(19) United States
(12) Patent Application Publication
(10) Pub. No.: US 2005/0201088 A1
(43) Pub. Date: Sep. 15, 2005

(54) Light fixture for cold temperature environments

(75) Inventors: Richard Stach, Eugene, OR (US); Lynn Post, Veneta, OR (US); Timothy Cary, Eugene, OR (US); Peter Greenberg, Albany, OR (US)

Correspondence Address: IPSOLON LLP, 805 SW BROADWAY, #2740, PORTLAND, OR, 97205, US

(73) Assignee: Energy Wise Lighting, Inc.

(21) Appl. No.: 11/056,832

(22) Filed: Feb. 11, 2005

Related U.S. Application Data
(60) Provisional application No. 60/552,938, filed on Mar. 11, 2004.

(51) Int. Cl. F21S 4/00

(52) U.S. Cl. 362/225; 362/249

(57) ABSTRACT

A cold temperature light fixture comprises an insulated housing having one or more ballasts and plural lamps to retain heat within enclosure so that ballasts and lamps start up more rapidly, and greater light output is obtained. The fixture may be operated in selected configurations and may include secondary heating elements within the fixture to warm ballasts. In one operating configuration, one or more of the ballasts is always energized and one or more of the lamps is preferably at least partially illuminated in an off mode. A sensor is operable to switch the fixture between the off and on mode, in which all ballasts are energized and all lamps illuminated.

### FIELD OF THE INVENTION

This invention relates generally to lighting fixtures, and more particularly to lighting fixtures designed for use in cold temperature environments.

### BACKGROUND

Cold temperature environments such as those found in cold storage facilities and remote locations where environmental temperatures are very low present unique engineering and design concerns for designing light fixtures that operate efficiently and effectively. Light fixtures used in cold environments must be designed to accomplish many of the same goals as standard light fixtures, such as generating sufficient light at sufficient quality for the application, and preferably with as much energy efficiently as possible. But extremely cold environments add numerous design and electrical constraints that are not found when designing lights for use in more temperate locations.

There are many types of light fixtures that have been used in cold environments, some have met with more success than others. In some instances, HID (“high intensity discharge”) fixtures are used in cold environments. However, these lamps were often simply left on all of the time because switching them on and off led to many problems when the fixtures were in cold environments. Leaving lamps on when they are not needed is obviously not an energy-efficient way to operate. Metal halide lamps have also been used in very cold environments, but the start-up time for such lamps is long and as a result, the lamps may not be emitting enough light when it is needed.

Fluorescent lamps have been used in cold environments as well. However, most kinds of fluorescent lamps operate poorly in cold temperatures. For one thing, many fluorescent lamps tend to start with more difficulty at lower temperatures. This is because the vapor pressure of mercury in the lamps is lower at low temperature and there is consequently less mercury available to start the lamp. Given the reduced level of mercury vapor in fluorescent lamps at low temperatures, the light output tends to be less at lower temperatures because the mercury is not emitting the optimum amount of ultraviolet energy for the phosphor to convert to visible light. As a result, standard fluorescent fixtures such as those using T12 and T8 lamps installed in very cold temperature environments do not produce 100% light output and are rarely used in such environments.

T5 fluorescent lamps and T5 high-output fluorescent lamps (“T5HO”) were developed in Europe and first introduced in the U.S. in the mid to late 1990s. T5 lamps are now being used in more kinds of fixtures because they can offer several functional advantages over the more frequently used T8 and T12 counterparts. The T5 lamps are relatively small compared to T8 and T12 lamps, provide a high lumen per watt output, and heat rapidly. However, given unique design constraints, as with other fluorescent lamps, T5 lamps have not been used historically in cold temperature environments.

There is an ongoing need therefore for improved lighting fixtures for use in cold temperature environments.

### SUMMARY OF THE INVENTION

The present invention is a light fixture designed for use in cold temperature environments. The fixture comprises an insulated housing in which the lamp ballasts are mounted on an insulated pad adjacent one another. One or more of the lamps is preferably kept at least partially illuminated at all times, or a secondary heat source such as a resistance heater is operated to retain heat in the housing. The fixture is preferably used with T5HO lamps.

### BRIEF DESCRIPTION OF THE DRAWINGS

The invention will be better understood and its numerous objects and advantages will be apparent by reference to the following detailed description of the invention when taken in conjunction with the following photographs and drawings.

FIG. 1 is a perspective view of one illustrated embodiment of a five-lamp fixture according to the present invention, with the reflector removed in order to expose the ballasts.

FIG. 2 is a cross sectional view of the lamp fixture shown in FIG. 1 taken along line 2-2 of FIG. 1, with the reflector reinstalled in the fixture.

FIG. 3 is a perspective view of the insulated housing used in accordance with the present invention.

FIG. 4 is a perspective view of one corner of a light fixture according to the present invention illustrating the hardware that allows the lens to be slid longitudinally into and out of the fixture housing to allow access to the lamps.

FIG. 5 a view similar to FIG. 4 showing the lens fully inserted into the housing and the access door in the closed position.

FIG. 6 is a cross sectional view of a fully assembled five-lamp fixture according to the present invention taken midway along the length of the fixture, through the ballasts.

FIG. 7 is a cross sectional view of the lighting fixture according to the present invention similar to the view of FIG. 6, taken midway along the length of the fixture, through the ballasts, and illustrating optional hinged insulated lens covers.

### DETAILED DESCRIPTION OF PREFERRED EMBODIMENTS

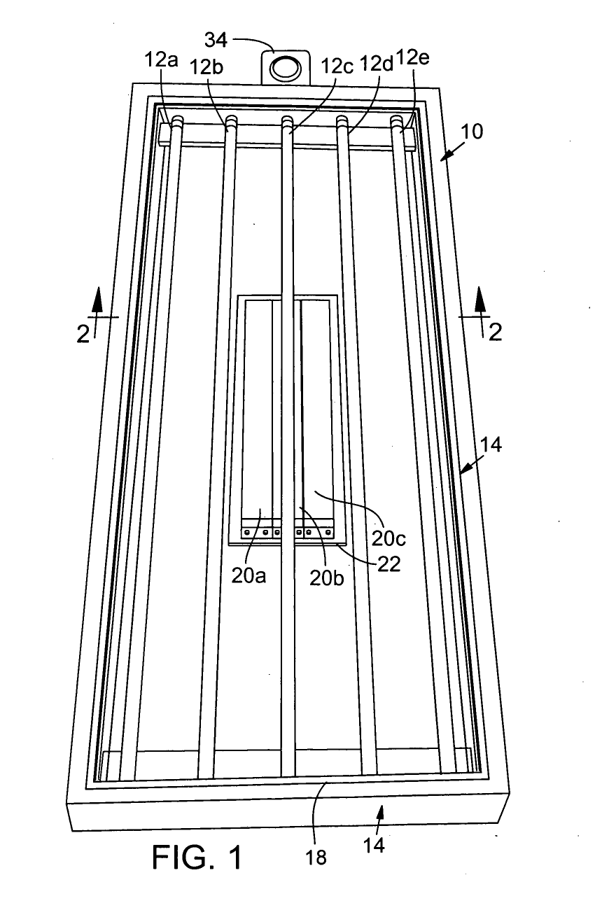

One preferred embodiment of a cold temperature lighting fixture 10 according to the present invention is shown in FIGS. 1 through 6. The fixture 10 shown in the drawings is designed to accommodate 5 fluorescent lamps of the T5HO type, referenced herein with numbers 12a, 12b, 12c, 12d and 12e. It will be appreciated that the invention is not limited to 5 lamps but instead may include greater or fewer depending upon the needs of the situation. Nonetheless, a five-lamp fixture is described herein to fully illustrate and detail the invention. Moreover, the principals of the invention are applicable to fixtures capable of using fluorescent lamps other than the T5HO types noted.

Referring now to FIGS. 1, 2 and 3, fixture 10 comprises an outer, insulated enclosure or housing 14 that provides an insulated enclosure for the five lamps 12 noted above and the other components of the fixture described herein. Housing 14 is defined by an outermost protective shell layer 15, which may be metal or plastic, and an insulating layer 16 which lies inwardly of outermost protective layer 15. Insulating layer 16 is preferably a foam such as a closed cell insulating foam having a high insulating value and high heat resistance. An inner housing shell 18 is received inwardly of the insulating layer 16. Inner housing shell 18 is preferably a metallic or plastic material. Inner housing shell 18 may optionally be coated with a heat-reflecting coating such as a ceramic paint. Such paints contain suspended particles of ceramic such as borosilicate, which reflect infrared radiation and by doing so contribute to maintaining the interior portions of fixture 10 in a relatively warmer condition than the exterior of the fixture.

Three ballasts, 20a, 20b and 20c are mounted immediately adjacent one another on an insulating pad 22 in inner housing shell 18. Although not shown in the drawing figures, appropriate electrical wiring connections are of course provided in fixture 10 between the external electrical source, the ballasts, the lamps and any other electrically controlled systems in fixture 10. Ballasts 20 are of the type appropriate for use with the lamps 12 used in the fixture in question—there are many types of ballasts available and selection of appropriate ballasts for use in a given fixture is well within the abilities of those of ordinary skill in the art. Ballasts 20 may preferably be of the dimmable type if desired, and may incorporate other functionality such as end-or-life protection systems and the like.

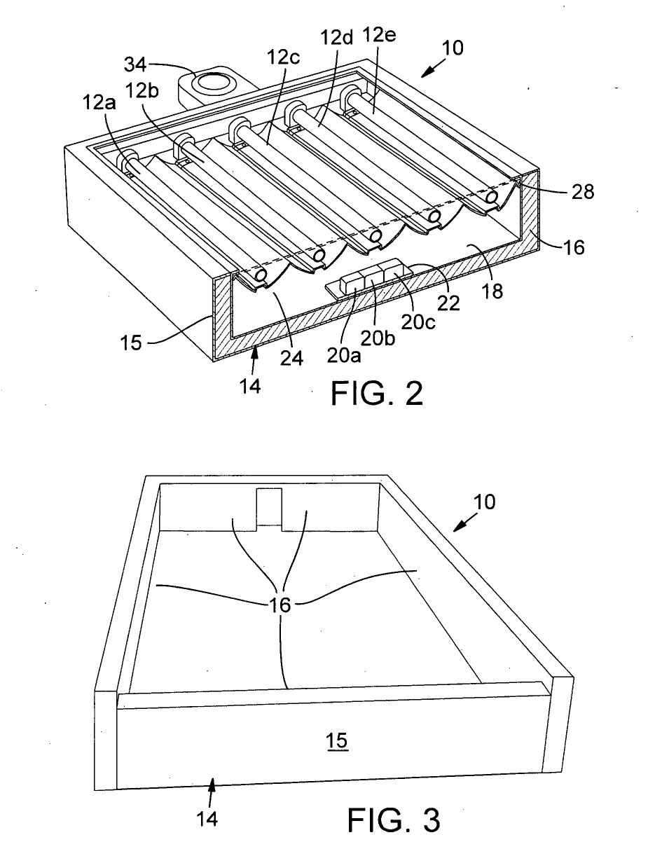

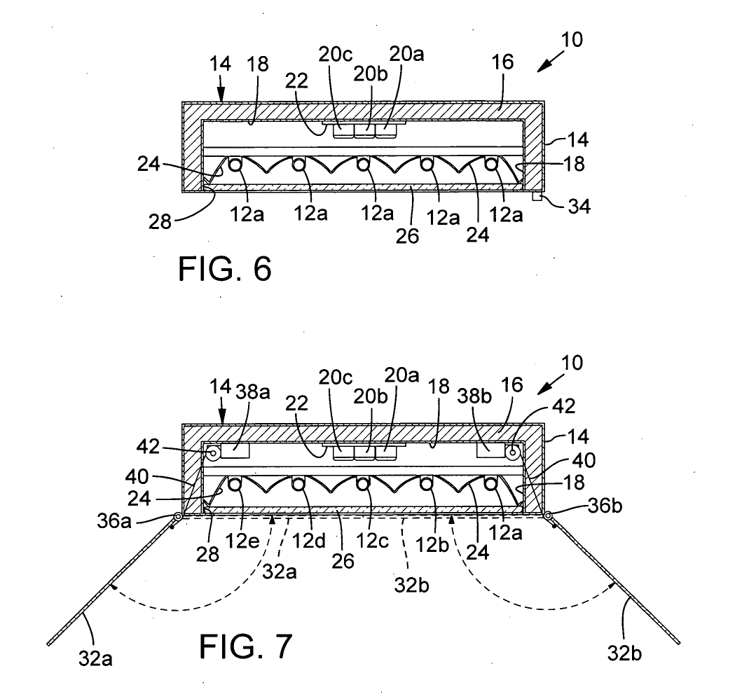

The ballasts 20 are mounted in fixture 10 such that adjacent ballasts are either in close physical proximity to one another, or are in physical contact with one another. Thus, with reference to the cross sectional views of FIGS. 2 and 6, ballast 20a is in an abutting contact with ballast 20b, and ballast 20b is in physical contact with ballast 20c, and so on if more than three ballasts are used. This manner of mounting the ballasts allows heat from the ballasts to be retained in the housing—the ballasts essentially perform the function of a heat sink. Alternately, the ballasts 20 may be mounted as near one another as possible, with the goal being to minimize the air space between adjacent ballasts so that heat is retained in the ballasts. In this regard, as used herein with respect to adjacent ballasts, the term close physical proximity means that the ballasts are mounted near enough one another as to minimize air space between the adjacent ballasts.

A removable reflector 24 is mounted between the ballasts 20 and the lamps 12 (see, e.g., FIGS. 2 and 6) and a lens 26 covers the lamps. The reflector is secured in place with, for example, screws that connect the reflector to socket bars (not shown) located at the opposite ends of the interior of the enclosure. Lens 26 is typically a plastic lens such as an acrylic material that slides longitudinally into channels or tracks 28 formed in the upper peripheral edges of layer 18 as detailed below. Lens 26 is shown in the figures as comprising a single layer of clear material, but may be provided as a double-pane, insulated lens for added thermal insulation.

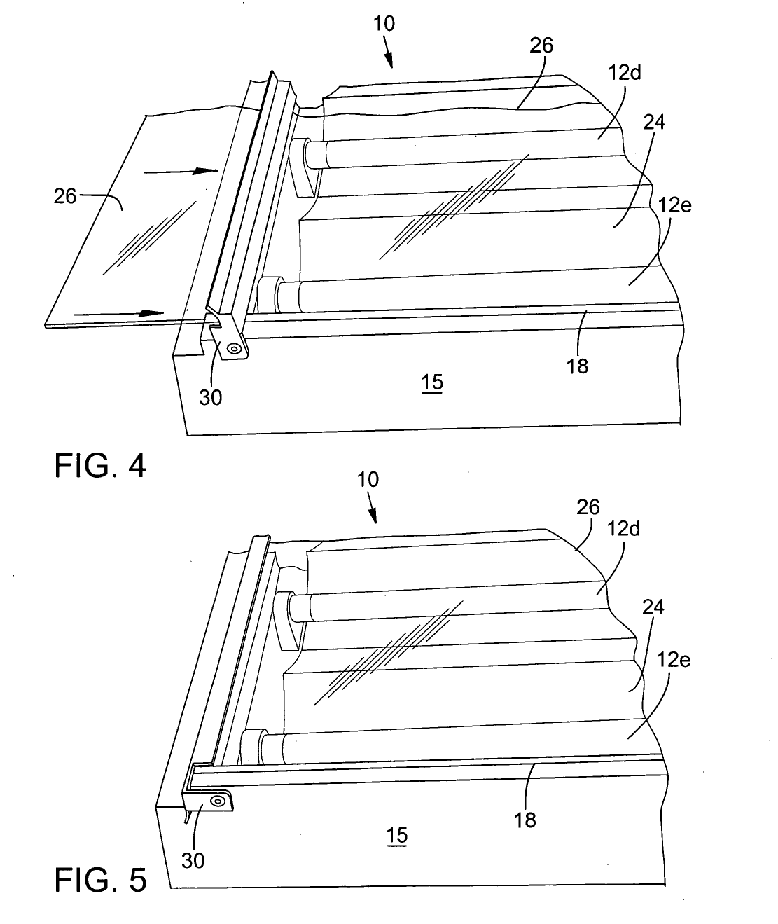

Referring to FIGS. 4 and 5, a hinged door 30 is provided at one end of layer 18 to allow lens 26 to be easily slid longitudinally into tracks 28 that are defined by the space between an upper edge of reflector 24 and an inwardly extending edge of layer 18. Thus, in FIG. 4 hinged door 30 is shown in the open position so that the lens 26 may be slid into and out of the tracks. When the lens is slid out of tracks 28 lamps 12 and ballasts 20 may be easily accessed for servicing and replacement. Lens 26 may include stop pins (not shown) intermediate along the length of the lens to prevent the lens from being inadvertently removed completely from tracks 28. Thus, when stop pins are used, the lens will slide outwardly only until the stop pins abut the hinged door 30. The width of the tracks 28 is designed to provide a snug seal between the lens 26 and the track to help insulate fixture 10. Gasket material may be included in tracks 28 if desired. Preferably, hinged door 30 includes gasket material to provide a tight, insulated seal. When the lens 26 is fully inserted into tracks 28 the hinged door 30 is moved into the closed position shown in FIG. 5 to retain the lens in place.

Fixture 10 is designed to be highly insulated. During manufacture, all of the seams in fixture 10 are sealed with caulk such as silicon caulk or other suitable caulks. With reference to FIG. 3, which illustrates the fixture 10 prior to installation of inner housing shell 18, all joints in the insulating layer 16 are sealed with caulk prior to installation of shell 18. The insulating layer 16 is installed in outer layer 15 so that there are no through joints or openings extending from the interior of fixture 10 to the exterior. All of the electrical components used in fixture 10, including ballasts 20 and lamps 12, are mounted on shell layer 18, and the insulating layer 16 is thus outside of the electrically energized space defined by the interior portion bounded by shell 18. The number of screws or rivets that extend through any of the layers is minimized.

As noted, ballasts 20a, 20b and 20c are mounted immediately adjacent one another on an insulating pad 22 that lies between the ballasts and inner shell 18. The ballasts normally generate heat when they are energized. Standard light fixtures are designed to dissipate the heat generated by the ballasts—typically this involves separating the ballasts by at least several inches. Some codes specify between ballast spacing of approximately 4 inches. In the present invention, mounting the ballasts immediately adjacent one another so that they are in physical contact or closely adjacent one another allows the heat from the ballasts to be retained in the fixture. Insulating pad 22 is preferably a plastic material that is a poor heat conductor and which has a high temperature rating. This further retains heat generated by the ballasts in the fixture. The ballasts 20 may be equipped with sensor circuits that allow the ballasts to cycle on and off if the temperature increases above a predetermined threshold.

The fixture 10 is connected to an external source of electricity with appropriate connections. In normal operating conditions the fixture operates in two different modes, referred to herein as the “off” mode and the “on” mode. The off mode is the mode that is used when full light output from the fixture is not required—for example, when there is no need for full light output. The fixture 10 switches to the on mode when full light output is required, for example, when personnel are working in the area where the fixture is mounted.

Referring to FIG. 1, a sensor 34 is preferably included with fixture 10. Sensor 34 is a motion sensor (also called an “occupancy sensor”) that is electrically connected to the ballasts 20 and which normally operates fixture 10 in the off mode. That is, absent motion in a predefined space that sensor 34 is capable of sensing, the fixture 10 is in the off mode. The sensor may be mounted in any appropriate location. When sensor 34 detects motion in a predefined space (i.e., when the space is occupied), it automatically switches fixture 10 to the on mode. When no motion is detected by sensor 34 for a predetermined interval of time, sensor 34 switches the fixture into the off mode.

Alternately, fixture 10 may be wired to traditional, manually operated switches.

Sensor 34 may include programmable control circuitry that allows the user to program in particular characteristics for the fixture in both on and off modes. Sensor 34 thus functions as a controller that is capable of controlling operation of fixture 10. In accordance with the present invention, in the off mode, one or more lamps 12 are preferably kept illuminated, or if the ballasts 20 are of the dimmable type, one or more lamps 12 are illuminated but dimmed. It is to be understood, therefore, that when fixture 10 is in the off mode, references to a lamp or ballast being “energized” refer equally to a lamp or ballast being partially energized, or dimmed. Thus, if dimmable ballasts are used, in the off mode at least one ballast is at least partially energized and at least one lamp is at least partially energized and illuminated. By keeping one or more lamps 12 and ballasts 20 energized or partially energized in this manner, the temperature inside the fixture (i.e., in the interior space bounded by lens 26 and shell 18) is elevated relative to the external temperature, yet keeps energy usage at a relatively low level. That is, the heat generated by the energized (or partially energized) ballast(s) and lamp(s) heats the interior of the fixture. It also provides some ambient lighting from the energized lamps 12, even if they are dimmed.

An alternate method of generating heat within the interior of the fixture is through use of a separate heat source inside the fixture for generating heat that is retained in the fixture interior. A secondary source of heat within the fixture is particularly desirable when dimmable ballasts are used. For example, most dimmable ballasts start up slowly if the temperature of the ballast is too low. In some instances, temperatures below 50° F. result in very poor start up performance for dimmable ballasts. It is therefore important to keep such ballasts at a relatively warm temperature to ensure good start up when the lamps are needed.

Resistance-type heaters are one type of separate heat source that suffice to keep the ballasts 20 warm. As one example, resistive strip heaters may be formed into a cylindrical sleeve. A sleeve encircles the striker end of each lamp so that the lamp illuminates more rapidly when energized. It will be appreciated that such a sleeve warms the lamp and does not directly warm the ballast. However, it does significantly improve lamp start up.

Another alternative secondary source of heat within the fixture is strip-type resistive heat tape that may applied to or wrapped around the exterior of ballasts 20 to thereby define a heating element for warming the ballasts, or may otherwise be located in the interior of the fixture to warm the ballasts. As noted above, ballasts of the dimmable type are known to be difficult to fire at low temperatures, and when the temperature drops below a threshold temperature, dimmable ballasts may not fire at all. Heat tape applied to such ballasts ensures that the ballasts will always perform properly. The secondary heat element defined by resistive heat tape and the like may remain in an energized state at all times when the lamps are off so that the ballasts remain warmed by the heat element, or the resistive heat tape may be cycled on and off to maintain the ballasts at a predetermined, desired temperature. The heat element may be either energized or de-energized when the lamps are on, depending upon the needs of the situation. A thermocouple or other temperature-sensing apparatus may be connected to the ballast to monitor its temperature and connected to the control system for the fixture. The secondary heat source may be cycled on and off under the control of the control system to regulate the temperature of the ballasts at a desired temperature when the fixture is off.

In the off mode, sensor 34 may also be set so that the ballasts 20 may be energized (or partially energized) on an intermittent, cyclical basis so that different lamps 12 are illuminated (or partially illuminated) at different times. This prevents constant illumination of one or more lamps 12 and concomitant use of only one ballast 20. For example, fixture 10 may be designed so that in the off mode ballast 20a is energized for N minutes or hours (N being some predetermined interval of time, typically in minutes or hours) and thus lamps 12 that are energized by ballast 20a are illuminated. At the end of N minutes or hours, ballast 20a switches off and ballast 20b is energized, illuminating the lamps 12 that are energized by ballast 20b. This state is maintained for N hours, until the next cycle where ballast 20b is switched off and ballast 20c is energized, and so on. Using this cycling system, each of the ballasts and lamps are energized for the same average operating hours and will thus have the same general life span, thereby significantly reducing lamp replacement and maintenance costs.

When sensor 34 detects motion in the predefined space below the sensor, fixture 10 is switched to the on mode. In this mode all of the ballasts 20 are fully energized and the associated lamps 12 are illuminated. Full illumination and light output occurs quickly because the heat generated by the illuminated lamp(s) and energized ballast in the off mode is retained in the fixture, or a small, separate heat source as described previously causes heat to be retained in the fixture.

With reference to FIG. 7, an insulated lens closure comprising paired hinged doors 32a and 32b is provided to cover the lens when the lamp is in a resting or “off” state and to help retain heat in the fixture 10. Hinged doors 32a and 32b are shown in their open position in solid lines in FIG. 7, and in dashed lines in the closed position. The doors 32 are connected to housing 14 with hinges 36a and 36b, respectively, and are operated between the open and closed positions with, for example, electric motors 38a and 38b. The motors 38 are illustrated as having an operable connection to the doors 32 by use of a cable 40 having one end connected to a door 32, and the opposite end wrapped around a pulley 42. However, any appropriate drive system for opening and closing the doors 32 will suffice. Motors 38 are operated by sensor 34. Thus, when the doors 32 are in the closed position the lamp is in the off mode. When motion is detected by sensor 34, the motors 38 open the doors and the fixture 10 is switched to the on mode, and vice versa.

The lens closure defined by doors 32a and 32b is optional.

Those of ordinary skill in the art will recognize that various equivalent modifications are available. As an example, fixture 10 may be equipped with four ballasts 20, each suited for energizing 2 lamps 12, but instead with each ballast 20 operating only one lamp 12. This tends to “overdrive” each of the four lamps 12 and the result is that the fixture 10 in the on mode delivers roughly 88% of the illumination of a fixture using 5 lamps as illustrated in FIGS. 1 through 7. Similarly, fixture 10 may be equipped with 2 lamps 12 and only one ballast 20. In this case the beneficial effect of having multiple ballasts mounted adjacent one another is lost, and so other means as described herein for retaining heat within the interior of the fixture may be utilized.

As yet another alternate, double pane glass such as low-E argon filled glass may be used for lens 26. Also, a multilayer plastic lens 26 may be used, and a low-E coating may be applied to the plastic lens.

As another means of retaining heat within the fixture 10 to thereby increase the turn-on speed of the fixture when it switches from the off mode to the on mode, a heat sink material that provides a thermal mass may be installed in the fixture adjacent the ballasts 20. As an example, a eutectic salt that is designed to change from solid to liquid phase as it absorbs and releases energy may be used.

Self-regulating heat tape may also be used as another source of resistance heating to keep the interior of fixture 10 warm when the fixture is in the off mode. This type of heat tape is capable of regulating itself: as the fixture 10 warms up, the heat tape senses that less heat is needed and thus draws less energy.

Finally, the fixture 10 may be designed in a manner that allows the fixture to be used in environments other than very cold areas. As an example, the housing components may be modular to allow, for example, the inner shell 18 and the electrical components (e.g., ballasts 20, lamps 12, sensor 34) to be removed from the insulating layer 16 and outer housing 14, then reinstalled in a different housing suited for use in relatively warmer conditions.

While the present invention has been described in terms of a preferred embodiment, it will be appreciated by one of ordinary skill that the spirit and scope of the invention is not limited to those embodiments, but extend to the various modifications and equivalents as defined in the appended claims.

1. A light fixture, comprising:
an insulated housing;
at least one ballast mounted on an insulated pad in the housing;
at least two lamps; and
a lens covering the lamps and enclosing the housing.

2. The light fixture according to claim 1 including at least two ballasts mounted on the insulated pad immediately adjacent one another.

3. The light fixture according to claim 1 wherein the fixture is operable in an off mode in which at least one ballast is energized and at least one lamp is illuminated, and an on mode in which each ballast is energized and each lamp is illuminated.

4. The light fixture according to claim 2 wherein the ballasts are mounted on the insulated pad such that each ballast is in close proximity with an adjacent ballast.

5. The light fixture according to claim 4 wherein the ballasts are mounted on the insulated pad such that each ballast is in physical contact with an adjacent ballast.

6. The light fixture according to claim 5 where said lens is slidably mounted in a channel formed in the housing and is movable in said channel between an open position and a closed position.

7. The light fixture according to claim 6 wherein said housing defines an interior surface and said interior surface is coated with a heat-reflective coating.

8. The light fixture according to claim 7 wherein the heat-reflective coating comprises a ceramic paint.

9. The light fixture according to claim 3 including a controller operably connected to the ballasts and capable of switching the ballasts between the off mode and the on mode.

10. The light fixture according to claim 9 wherein the controller is a motion sensor.

11. A cold environment light fixture, comprising:
insulated housing means for providing an insulated enclosure for mounting at least one ballast and plural lamps, said insulated housing means including an insulating pad for mounting said at least one ballast;
control means for operating the fixture in a first mode in which said at least one ballast is energized and at least one lamp is illuminated, and a second mode in which said at least one ballast is energized and all of the lamps are illuminated.

12. The cold environment light fixture according to claim 11 wherein said insulated housing means provides an insulated enclosure for mounting at least two ballasts on said insulated pad such that said at least two ballasts are in close proximity to one another.

13. The cold environment light fixture according to claim 11 wherein the control means further comprises control means for partially energizing said at least one ballast and at least one lamp in the first mode.

14. The cold environment light fixture according to claim 11 wherein said control means further comprises a sensor for automatically switching said fixture between said first and second modes.

15. The cold environment light fixture according to claim 11 including doors covering a lens and said doors movable between a closed position and an open position, and including motor means for moving said doors into the open position when said fixture is in said second mode, and for moving said doors into the closed position when said fixture is in said first mode.

16. A method of retaining heat in a fluorescent lamp fixture in cold environments, comprising the steps of:
a) mounting at least two lamps in an insulated housing;
b) mounting at least one ballast on an insulated pad in the insulated housing; and
c) energizing at least intermittently the at least one ballast and at least one of the lamps.

17. The method according to claim 16 including the step of mounting at least two ballasts on said insulated pad so that the ballasts are in physical contact.

18. The method according to claim 17 including the step of operating said lamp fixture in a first mode in which less than all of the ballasts are energized and less than all of the lamps are energized.

19. The method according to claim 18 including the step of operating said lamp fixture in a second mode in which all of the ballasts are energized and all of the lamps are energized.

20. The method according to claim 19 wherein in the first mode an energized ballast is partially energized.

21. A fluorescent light fixture, comprising:
an insulated housing;
at least one dimmable ballast mounted on an insulated pad in the housing and a heating element in proximity to the at least one dimmable ballast;
at least two lamps; and
a lens covering the lamps.

22. The fluorescent light fixture according to claim 21 wherein the heating element further comprises a resistive heating element.

23. The fluorescent light fixture according to claim 22 wherein the heating element further comprises a resistive heating element of the strip type, and wherein said strip is applied to said ballast.

24. The fluorescent light fixture according to claim 21 wherein said heating element is maintained in an energized state to thereby heat said at least one dimmable ballast at all times that the lamps are not illuminated.
